(19) United States
(12) Patent Application Publication
(10) Pub. No.: US 2024/0365201 A1
(43) Pub. Date: Oct. 31, 2024

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jiangsheng FAN, Dongguan (CN); Xin YOU, Dongguan (CN)

(73) Assignee: GUANGDONG OPPO MOBILE TELECOMMUNICATIONS CORP., LTD., Dongguan (CN)

(21) Appl. No.: 18/763,707

(22) Filed: Jul. 3, 2024

Related U.S. Application Data
(63) Continuation of application No. PCT/CN2022/072614, filed on Jan. 18, 2022.

(51) Int. Cl. H04W 36/36

(52) U.S. Cl. CPC H04W 36/362

(57) ABSTRACT

A communication method, a terminal device, and a network device are provided. The method includes: If a first condition is met, a terminal device starts a handover condition evaluation task related to conditional handover; and/or if a second condition is met, the terminal device stops or skips starting the handover condition evaluation task related to the conditional handover. The handover condition evaluation task related to the conditional handover is used to evaluate whether a conditional handover event associated with a first conditional handover target cell is met. The first conditional handover target cell is one of at least one conditional handover target cell corresponding to conditional handover configuration information configured by the network device. The conditional handover configuration information configured by the network device includes configuration information corresponding to the at least one conditional handover target cell.

### CROSS-REFERENCE TO RELATED APPLICATIONS

This application is a continuation of International Application No. PCT/CN2022/072614, filed on Jan. 18, 2022, the disclosure of which is hereby incorporated by reference in its entirety.

### TECHNICAL FIELD

This application relates to the field of communications technologies, and more specifically, to a communication method, a terminal device, and a network device.

### RELATED ART

A conditional handover mechanism can improve robustness in a handover process of a terminal device. Different from that in a conventional handover technology, a conditional handover command may be sent to the terminal device very early. After receiving the conditional handover command, the terminal device does not immediately execute the handover command, but first starts a handover condition evaluation task related to conditional handover, to evaluate whether a conditional handover event associated with one or more conditional handover target cells is met. If the conditional handover event is met, the terminal device may be handed over to a conditional handover target cell associated with the conditional handover event. In addition, after the conditional handover succeeds, the terminal device deletes all stored conditional handover configuration information. Currently, to reduce overheads required by a network device to configure the conditional handover configuration information for the terminal device, the terminal device is configured to no longer delete all the stored conditional handover configuration information after the conditional handover succeeds. However, a conditional handover behavior of the terminal device after the conditional handover succeeds is not specified in an existing communications protocol. This may cause relatively low efficiency of the terminal device in executing the handover condition evaluation task related to the conditional handover.

### SUMMARY

This application provides a communication method, a terminal device, and a network device.

According to a first aspect, a communication method is provided, including: If a first condition is met, a terminal device starts a handover condition evaluation task related to conditional handover; and/or if a second condition is met, the terminal device stops or skips starting the handover condition evaluation task related to the conditional handover. The handover condition evaluation task related to the conditional handover is used to evaluate whether a conditional handover event associated with a first conditional handover target cell is met. The first conditional handover target cell is one of at least one conditional handover target cell corresponding to conditional handover configuration information configured by a network device. The conditional handover configuration information configured by the network device includes configuration information corresponding to the at least one conditional handover target cell.

According to a second aspect, a communication method is provided, including: A network device sends a reconfiguration message to a terminal device. The reconfiguration message is used to instruct a terminal device to start a handover condition evaluation task related to conditional handover, and/or the reconfiguration message is used to instruct the terminal device to stop or skip starting the handover condition evaluation task related to the conditional handover. The handover condition evaluation task related to the conditional handover is used to evaluate whether a conditional handover event associated with a first conditional handover target cell is met. The first conditional handover target cell is one of at least one conditional handover target cell corresponding to conditional handover configuration information configured by the network device. The conditional handover configuration information configured by the network device includes configuration information corresponding to the at least one conditional handover target cell.

According to a third aspect, a terminal device is provided, including a processor and a memory. The memory is configured to store one or more computer programs. The processor is configured to invoke the computer program in the memory, to cause the terminal device to perform some or all of the steps in the method in the first aspect.

In embodiments of this application, if the first condition is met, the terminal device starts the handover condition evaluation task related to the conditional handover; and/or if the second condition is met, the terminal device stops or skips starting the handover condition evaluation task related to the conditional handover. In other words, the terminal device may determine, based on the first condition and/or the second condition, to start or skip starting (or stop) the handover condition evaluation task related to the conditional handover. In this way, the following case is avoided: In a conventional conditional handover mechanism, the terminal device may constantly execute, based on the stored conditional handover configuration information, the handover condition evaluation task related to the conditional handover.

### BRIEF DESCRIPTION OF DRAWINGS

FIG. 1 is a schematic diagram of an EN-DC dual connectivity architecture.

FIG. 2 is a schematic diagram of a networking manner in an EN-DC dual connectivity scenario.

FIG. 3 is a schematic diagram of a networking manner in an EN-DC dual connectivity scenario.

FIG. 4 is a schematic diagram of a networking manner of a control plane in an EN-DC dual connectivity scenario.

FIG. 5 is a schematic diagram of a communications system to which an embodiment of this application is applicable.

FIG. 6 is a schematic diagram of a communication method according to an embodiment of this application.

FIG. 7 is a schematic diagram of a communication method according to another embodiment of this application.

FIG. 8 is a schematic diagram of a terminal device according to an embodiment of this application.

FIG. 9 is a schematic diagram of a network device according to an embodiment of this application.

FIG. 10 is a schematic structural diagram of a communications apparatus according to an embodiment of this application.

### DESCRIPTION OF EMBODIMENTS

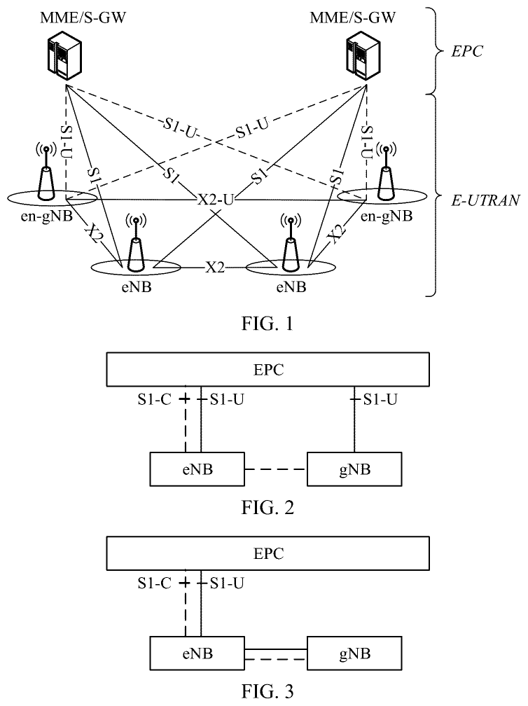

The following describes technical solutions of this application with reference to the accompanying drawings. For ease of understanding of this application, communication processes involved in embodiments of this application are first described below with reference to FIG. 1 to FIG. 5.

### Dual Connectivity Communication Scenario

A method provided in embodiments of this application may be applied to various multiple RAT dual connectivity (MR-DC) architectures, for example, dual connectivity of a fourth-generation (4G) communications system and a fifth-generation (5G) communications system, dual connectivity of a 5G communications system and a 4G communications system, dual connectivity of a 5G communications system and a 5G communications system, or the like.

The dual connectivity of a 4G communications system and a 5G communications system may include: evolved universal terrestrial radio access (E-UTRA) system and new radio (NR) system dual connectivity (E-UTRA-NR dual connectivity, EN-DC), and E-UTRA system and NR system dual connectivity (NG-RAN E-UTRA-NR dual connectivity, NGEN-DC) in a 5G core network. The EN-DC may also be referred to as an option 3 series.

FIG. 1 is a schematic diagram of an EN-DC dual connectivity architecture. With reference to FIG. 1, the EN-DC is a DC by taking a long term evolution (LTE) base station (for example, an eNB) as a master node (MN) or a primary base station and taking an NR base station (for example, a gNB) as a secondary node (SN) or a secondary base station. In addition, the MN and the SN may separately establish a data plane connection to an evolved packet core (EPC) network (that is, a 4G core network), to provide an air interface transmission resource for data between a terminal device and the EPC. The EPC may include a mobility management entity (MME) and/or a serving gateway (S-GW).

It should be noted that an S1 interface is a communications interface between an LTE base station and the EPC in the architecture shown in FIG. 1. Based on different types of information transmitted by using the S1 interface, the S1 interface may be further classified into an S1-U interface and an S1-C interface. The S1-U interface may be configured to transmit user plane data. The S1-C interface may be configured to transmit control plane signalling.

With reference to two networking manners shown in FIG. 2 to FIG. 3, the following describes a manner of connection between a terminal device and a network device in an EN-DC dual connectivity scenario.

With reference to FIG. 2, an S1-U interface and an S1-C interface are established between an EPC and an LTE eNB serving as an MN, and an S1-U interface is established between the EPC and a gNB serving as an SN. In this architecture, control plane signalling between the EPC and a base station can be transmitted only between the EPC and the LTE eNB, and then the LTE eNB forwards the specific control plane signalling to the gNB. User plane data may be separately transmitted between the EPC and the LTE eNB and between the EPC and the gNB.

With reference to FIG. 3, an S1-U interface and an S1-C interface are established between an EPC and an LTE eNB serving as an MN, and a gNB serving as an SN does not directly communicate with the EPC. In this architecture, control plane signalling and user plane data between the EPC and a base station can be transmitted only between the EPC and the LTE eNB, and then the LTE eNB transmits the specific control plane signalling and/or the user plane data to the gNB.

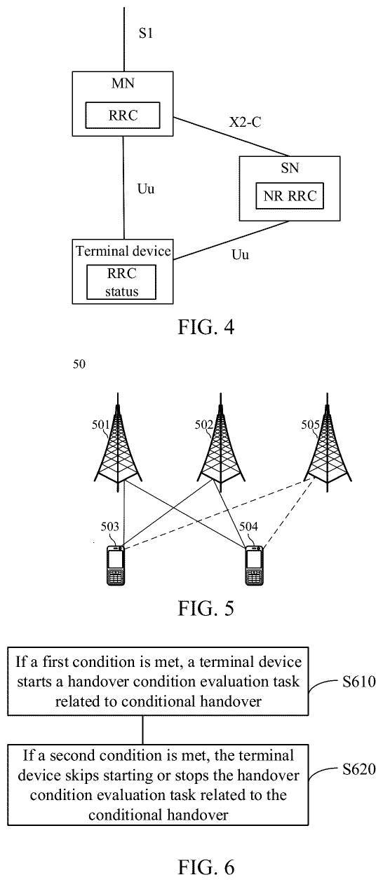

It should be noted that an RRC entity may be disposed in both the MN and the SN in both the networking manners shown in FIG. 2 and FIG. 3, to generate an RRC PDU, referring to FIG. 4. However, at a same time, the terminal device usually has only one RRC state machine and is based on an MN side.

It should be further noted that a signalling bearer in LTE may include a signalling radio bearer (SRB)0, an SRB1, and an SRB2. On this basis, the EN-DC can further support an SRB3. The SRB3 is used to transmit RRC signalling between the SN and the terminal device. Generation of the signalling bearer does not require resource negotiation and UE capability negotiation with the MN. In addition, to improve reliability of transmission of the SRB1 and the SRB2, the EN-DC may further support split SRB1 and split SRB2. To be specific, a packet data convergence protocol protocol data unit (PDCP PDU) corresponding to an RRC message generated by the MN is repeatedly transmitted on an SN side.

The NGEN-DC may also be referred to as an option 7 series. The NG EN-DC is DC by taking an LTE base station (for example, an ng-eNB) as an MN and taking an NR base station (for example, a gNB) as an SN. Different from the EN-DC, in the NG EN-DC, both the MN and the SN may be connected to a 5G core network (5GC), to provide an air interface transmission resource for data between the terminal device and the 5GC.

The dual connectivity of the 5G communications system and the 4G communications system may include NR system and E-UTRA system dual connectivity (NRE-UTRA dual connectivity, NE-DC), and the like. The NE-DC may also be referred to as an option 4 series. The NE-DC takes an NR base station (for example, a gNB) as an MN and takes an LTE base station (for example, an ng-eNB) as an SN. The MN and the SN may be separately connected to the 5GC on a data plane, to provide an air interface transmission resource for data between the terminal device and the 5GC.

The dual connectivity of a 5G communications system and a 5G communications system may include DC of an NR system and an NR system. The MN and the SN are both NR base stations in the DC of an NR system and an NR system.

The following describes a communications system to which an embodiment of this application is applicable, only by using a communications system 50 shown in FIG. 5 as an example.

FIG. 5 is a schematic diagram of an architecture of a communications system 50 according to an embodiment of this application. In FIG. 5, the communications system 50 may include a network device 501, a network device 502, a network device 505, a terminal device 503, and a terminal device 504. FIG. 5 is merely a schematic diagram, and does not constitute a limitation on a scenario to which the technical solutions provided in this application are applicable.

The network device in FIG. 5, that is, the network device 501, the network device 502, or the network device 505, may be any device that has wireless receiving and transmitting functions. The network device includes but is not limited to an evolved NodeB (evolutional NodeB, NodeB or eNB or e-NodeB) in LTE, a base station (gNodeB or gNB) or a transmission reception point (TRP) in NR, 3GPP subsequent evolution, and the like. The base station may be a macro base station, a micro base station, a picocell base station, a small cell, a relay station, a balloon station, or the like. A plurality of base stations may support networks of a same technology mentioned above, or may support networks of different technologies mentioned above. The base station may include one or more co-site or non-co-site TRPs. The network device may alternatively be a radio controller, a central unit (CU), and/or a distributed unit (DU) in a cloud radio access network (CRAN) scenario.

A terminal in FIG. 5, that is, the terminal device 503 or the terminal device 504 is a device having wireless receiving and transmitting functions, and may be deployed on land, including indoor or outdoor, handheld, wearable or vehicle-mounted, may be deployed on water (for example, on a ship), or may be deployed in air (for example, on an airplane, a balloon, or a satellite). The terminal may be a mobile phone, a tablet computer (Pad), a computer with wireless receiving and transmitting functions, a virtual reality (VR) terminal device, an augmented reality (AR) terminal device, a terminal in industrial control, a vehicle-mounted terminal device, a terminal in self-driving, a terminal in auxiliary driving, a terminal in remote medical, a terminal in a smart grid, a terminal in transportation safety, a terminal in a smart city, a terminal in a smart home, or the like. An application scenario is not limited in embodiments of this application. The terminal may be sometimes referred to as a terminal device, user equipment (UE), an access terminal, a vehicle-mounted terminal, an industrial control terminal, a UE unit, a UE station, a mobile station, a mobile console, a remote station, a remote terminal, a mobile device, a UE terminal device, a wireless communications device, a machine terminal, a UE proxy, a UE apparatus, or the like. The terminal may be fixed or mobile.

As an example instead of a limitation, in embodiments of this application, the terminal may alternatively be a wearable device. The wearable device may also be referred to as a wearable intelligent device, and is a general term for wearable devices such as glasses, gloves, watches, clothes, and shoes that are intelligently designed and developed by applying wearable technologies to daily wearing. The wearable device is a portable device that can be directly worn or integrated into clothes or accessories of a user. In addition to being a hardware device, the wearable device can also realize various functions through software support, data exchange, and cloud interaction. In a broad sense, wearable smart devices may include a full-featured and large-sized device that can provide full or partial functions without relying on a smartphone, for example, a smart watch or smart glasses, and a device that only focuses on a specific type of application function and needs to cooperate with another device such as a smartphone for use, for example, various smart bracelets and smart jewelries for physical sign monitoring.

### Cell Handover

Cell handover (HO) aims at improving continuity of services provided by a communications system for a terminal device. In a wireless communications system, when a terminal device is moved from a cell (also referred to as a “source cell”) to another cell, the terminal device needs to be handed over to the another cell (also referred to as a “target cell”) to maintain communication. The cell may be a primary cell (PCell) or a primary secondary cell (PSCell). Usually, the cell handover may be classified into two types: a conventional handover mechanism and a conditional handover mechanism.

For the conventional handover mechanism, to improve continuity of services provided by a communications system for a terminal device in a connected mode, a network device sends a handover command to the terminal device in an appropriate occasion (for example, a signal measurement result of a terminal device in a serving cell is less than a threshold), to instruct the terminal device to perform cell handover. In some implementations, the foregoing handover command may be an RRC reconfiguration message that includes synchronization reconfiguration information.

For the conditional handover (CHO) mechanism, the network device may configure a configuration of one or more target cells and a conditional handover event associated with the one or more conditional handover target cells for the terminal device. Correspondingly, the terminal device may execute a handover condition evaluation task to evaluate whether the foregoing conditional handover event associated with the one or more conditional handover target cells is met. When the one or more conditional handover events associated with the one or more conditional handover target cells are met, the terminal device may be handed over from a source cell (or referred to as a “current serving cell”) to a corresponding conditional handover target cell whose conditional handover event is met. Currently, the foregoing conditional handover mechanism may be applied to a conditional PSCell addition scenario, a conditional PSCell change scenario, and a conditional PCell change scenario. It should be noted that, in the conditional PSCell addition scenario and/or the conditional PSCell change scenario, the foregoing conditional handover target cell is a target PSCell, and the source cell is a source PSCell. In the conditional PCell change scenario, the foregoing conditional handover target cell is a target PCell, and the source cell is a source PCell.

In the conditional primary secondary cell addition/change (conditional PSCell addition/change, CPAC) scenario, a source PCell or a source PSCell sends conditional handover configuration information to a terminal device. The conditional handover configuration information includes configuration information of at least one conditional addition/change target PSCell and handover condition configuration information associated with each conditional addition/change target PSCell. Correspondingly, after the terminal device succeeds in performing conditional handover based on the handover configuration information, the terminal device deletes all stored configuration information of the conditionally added/changed target PSCell and conditional handover configuration information of each conditional addition/change target PSCell. That the terminal device succeeds in performing the conditional handover based on the handover configuration message may be understood as that the terminal device succeeds in accessing a conditional handover target PSCell.

In the conditional PCell change scenario, a source PCell may send conditional handover configuration information to a terminal device. The conditional handover configuration information includes configuration information of at least one conditional handover target PCell and conditional handover configuration information associated with each conditional handover target PCell. Correspondingly, after the terminal device succeeds in performing the conditional handover based on the handover configuration message, the terminal device deletes all previously stored configuration information of the conditional handover target PCell and the conditional handover configuration information associated with each conditional handover target PCell. That the terminal device succeeds in performing the conditional handover based on the handover configuration information may be understood as that the terminal device succeeds in accessing a conditional handover target PCell.

In some implementations, the foregoing conditional handover configuration information includes the configuration information associated with the at least one conditional handover target cell. Configuration information associated with any conditional handover target cell in the at least one conditional handover target cell may include one or more of a configuration parameter 1, a configuration parameter 2, and a configuration parameter 3.

The configuration parameter 1 includes a logical identifier ID that is a logical number used to identify a CHO configuration, a CPA configuration, or a CPC configuration. In some implementations, the foregoing configuration parameter 1 may include a parameter CondReconfigId.

The configuration parameter 2 includes configuration information of a conditional handover target cell. The terminal device may be handed over to the conditional handover target cell based on the configuration information of the conditional handover target cell. In some implementations, the foregoing configuration parameter 2 may include one or more of the following configuration information: a physical layer configuration that needs to be used by the terminal in the conditional handover target cell, a medium access control (MAC) layer configuration that needs to be used by the terminal in the conditional handover target cell, a radio link control (RLC) layer configuration that needs to be used by the terminal in the conditional handover target cell, a data radio bearer (DRB)—related configuration that needs to be used by the terminal in the conditional handover target cell,—configuration related to a frequency band and a bandwidth that are supported by the conditional handover target cell, and a random access configuration.

The configuration parameter 3 is a handover condition configuration. In some implementations, the configuration parameter 3 may include at least one measurement ID. One measurement ID is associated with one measurement object (MO) configuration and one measurement reporting configuration. In some implementations, the foregoing measurement reporting configuration may include a conditional handover event. The conditional handover event is used by the terminal device to determine whether to trigger handover to a conditional handover target cell associated with the conditional handover event. Therefore, the conditional handover event may also be referred to as a “conditional handover trigger condition” or a “conditional handover-related handover condition”.

In some other implementations, a conditional handover event type of the conditional handover event may include at least one of a condition A3 event, a condition A4 event, a condition A5 event, a DI event, and a TI event.

The condition A3 event includes that a measurement result of a conditional handover target cell is higher than a measurement result of a current serving cell in which the terminal device is located, and a difference between the measurement result of the conditional handover target cell and the measurement result of the current serving cell is greater than or equal to a first threshold.

The condition A4 event includes that a measurement result of a conditional handover target cell is greater than or equal to a second threshold.

The condition A5 event includes that a measurement result of a current serving cell in which the terminal device is located is less than a third threshold, and a measurement result of a conditional handover target cell is higher than a fourth threshold.

The condition DI event includes that a distance between the terminal device and a location reference point 1 is greater than a fifth threshold, and a distance between the terminal device and a location reference point 2 is less than a sixth threshold.

The condition TI event includes that a local time of the terminal device exceeds a configured time 1 but does not exceed a configured time 2, where the time 2 is later than the time 1.

In some implementations, one conditional handover target cell may be associated with only one piece of conditional handover event configuration information. To be specific, a configuration parameter 3 associated with one conditional handover target cell includes only one measurement ID.

In some other implementations, one conditional handover target cell may be associated with at least two pieces of conditional handover event configuration information, or a configuration parameter 3 associated with one conditional handover target cell includes at least two measurement IDs. In this case, that the conditional handover event associated with the conditional handover target cell is met may include two cases. In a case 1, only when the conditional handover events corresponding to the at least two pieces of conditional handover event configuration information are met (or triggered), it is considered that a handover condition associated with the conditional handover target cell is met. In a case 2, when at least one of the conditional handover events corresponding to the at least two pieces of conditional handover event configuration information is met, it is considered that the conditional handover event associated with the conditional handover target cell is met.

It should be noted that one or more parameters of the first threshold, the second threshold, the third threshold, the fourth threshold, the fifth threshold, the sixth threshold, the time 1, and the time 2 may be configured by the network device for the terminal device. For example, the network device may perform configuration by using a system broadcast message or dedicated signalling.

In some implementations, a configuration format of the time 2 may include two types. In a configuration format 1, the time 2 may be a universal time coordinated (UTC) time. For example, the configuration format of the time 2 may be a year/month/day/hour/minute/second form, for example, 2021.11.25 17:43:05. In a configuration format 2, the time 2 may be determined based on the time 1. For example, the time 2 may be a time after a fixed duration from the time 1 as a start time. For example, the time 2 is a corresponding time after 20 seconds from the time 1. Certainly, the time 2 may alternatively use another configuration format.

The foregoing describes that the terminal device may execute a handover condition evaluation task related to conditional handover to evaluate whether a conditional handover event associated with the one or more conditional handover target cells is met. In some implementations, if the conditional handover configuration information stored by the terminal device includes handover condition configuration information associated with a plurality of conditional handover target cells, that the terminal device starts the handover condition evaluation task related to the conditional handover may be understood as that the terminal device needs to evaluate a conditional handover event associated with each conditional handover target cell (that is, the conditional handover event included in the configuration parameter 3 associated with each conditional handover target cell), to determine whether the conditional handover event of each conditional handover target cell is met. In other words, a behavior that the terminal device starts to evaluate whether the conditional handover event is met may be understood as executing or starting the handover condition evaluation task related to the conditional handover. Correspondingly, that the terminal device does not execute the handover condition evaluation task may be classified into two cases. In a case 1, the terminal device stops the handover condition evaluation task. To be specific, the terminal device originally executes (or starts) the handover condition evaluation task, but the terminal device stops the handover condition evaluation task for some reasons (for example, if a second condition is met below). In a case 2, the terminal device does not start the handover condition evaluation task. In other words, the terminal device keeps not executing the handover condition evaluation task.

For ease of understanding, the following describes conditional handover with reference to FIG. 5 by using a CPAC process as an example. It should be noted that a conditional PCell change process is similar to the CPAC process. For brevity, details are not separately described. In addition, for ease of distinguishing between a conditional handover target PSCell included in a conditional handover configuration and a conditional handover target PSCell to which the terminal device is handed over through conditional handover, in the following, the conditional handover target PSCell included in the conditional handover configuration is referred to as a “candidate PSCell”, and the conditional handover target PSCell to which the terminal device is handed over through the conditional handover is referred to as a “target PSCell”.

In FIG. 5, the terminal device 503 or the terminal device 504 may implement dual connectivity to the network device 505 and the network device 502, where one network device is an MN and the other network device is an SN. One or more serving cells of the MN belong to a master cell group (MCG). Usually, the MCG may include a primary cell (PCell). In some implementations, in addition to the PCell, the MCG may further include one or more secondary cells (SCell). One or more serving cells of the SN belong to a secondary cell group (SCG). Usually, the SCG may include a PSCell. In some implementations, in addition to the PSCell, the SCG may further include one or more SCells.

In the communications system 50 shown in FIG. 5, the terminal device 503 or the terminal device 504 may perform CPAC. For example, the terminal device 503 may perform conditional primary secondary cell addition (conditional PSCell addition, CPA) by using the following example 5, and perform conditional primary secondary cell change (conditional PSCell change, CPC) by using the following example 2.

In the example 5, for example, the terminal device 503 establishes an RRC connection to the network device 501, and the terminal device 503 needs to perform CPA to establish a connection to the network device 502. After establishing an RRC connection to the terminal device 503, the network device 501 may configure one or more candidate PSCells (that is, the foregoing described conditional PSCell addition: CPA) for the terminal device 503. The one or more candidate PSCells include a PSCell configured by the network device 502 for the terminal device 503 and a PSCell configured by another network device for the terminal device 503. The network device 501 sends configuration information 1 of the one or more candidate PSCells to the terminal device 503. The configuration information 1 of the candidate PSCell includes a configuration 1 and an addition condition (that is, the foregoing described handover condition configuration information) of the candidate PSCell. The terminal device 503 receives the configuration information 1 of the one or more candidate PSCells from the network device 501, may detect the addition condition associated with the one or more candidate PSCells. When detecting at least one candidate PSCell that meets the addition condition, the terminal device 503 selects one candidate PSCell (for example, the candidate PSCell configured by the network device 502 for the terminal) and applies a configuration of the candidate PSCell. Subsequently, the terminal device 503 initiates random access to the candidate PSCell, and establishes dual connectivity to the network device 502 after successful random access to the candidate PSCell. The configuration information 1 of the candidate PSCell may also be referred to as CPA configuration information 1 of the candidate PSCell or conditional handover configuration information related to CPA of the candidate PSCell. A name of the configuration information is not limited in this embodiment of this application.

It may be understood that when detecting a plurality of candidate PSCells that meet the addition condition, the terminal device 503 may select one candidate PSCell according to a preset policy and apply a configuration of the candidate PSCell. For example, when detecting a plurality of candidate PSCells that meet the addition condition, the terminal device 503 may randomly select one candidate PSCell and apply a configuration of the candidate PSCell. Alternatively, the terminal device 503 may select a candidate PSCell with the best signal quality from the plurality of candidate PSCells that meet the addition condition and apply a configuration of the candidate PSCell. Alternatively, the terminal device 503 may select a candidate PSCell with the largest quantity of beams from the plurality of candidate PSCells that meet the addition condition and whose quantities of beams are greater than or equal to a threshold and apply a configuration of the candidate PSCell. The foregoing are merely examples in which the terminal device 503 selects a candidate PSCell. The terminal device 503 may alternatively select a candidate PSCell in another manner. This is not limited.

In the example 2, for example, the terminal device 503 establishes dual connectivity to the network device 501 and the network device 502, the network device 501 is an MN, the network device 502 is an SN, and the terminal device 503 needs to perform CPC. The network device 505 may configure one or more candidate PSCells (that is, the foregoing described conditional PSCell change) for the terminal device 503 by using the network device 501 or the network device 502. The network device 501 or the network device 502 sends configuration information 2 of the one or more candidate PSCells to the terminal device 503. The configuration information 2 of the candidate PSCell includes a configuration 2 and a change condition (that is, the foregoing described handover condition configuration information) of the candidate PSCell. The terminal device 503 receives the configuration information 2 of the one or more candidate PSCells from the network device, and may detect the change condition of the one or more candidate PSCells. When detecting at least one candidate PSCell that meets the change condition, the terminal device 503 selects one candidate PSCell and applies a configuration of the candidate PSCell. Subsequently, the terminal device 503 initiates random access to the candidate PSCell, and establishes, after successful random access to the candidate PSCell, dual connectivity to the network device 501 and a secondary base station to which the candidate PSCell belongs. The configuration information 2 of the candidate PSCell may also be referred to as CPC configuration information 2 of the candidate PSCell, or may also be referred to as CPC-related conditional handover configuration information of the candidate PSCell. This is not limited.

It may be understood that when detecting a plurality of candidate PSCells that meet the change condition, the terminal device 503 may select one candidate PSCell according to a preset policy and apply a configuration of the candidate PSCell. For example, when detecting a plurality of candidate PSCells that meet the change condition, the terminal device 503 may randomly select one candidate PSCell and apply a configuration of the candidate PSCell. Alternatively, the terminal device 503 may select a candidate PSCell with the best signal quality from the plurality of candidate PSCells that meet the change condition and apply a configuration of the candidate PSCell. Alternatively, the terminal device 503 may select a candidate PSCell with the largest quantity of beams from the plurality of candidate PSCells that meet the change condition and whose quantities of beams are greater than or equal to a threshold and apply a configuration of the candidate PSCell. The foregoing are merely examples in which the terminal device 503 selects a candidate PSCell. The terminal device 503 may alternatively select a candidate PSCell in another manner. This is not limited.

It should be noted that, in this embodiment of this application, for any candidate PSCell in one or more candidate PSCells configured by any network device for the terminal, configuration information 1 of the candidate PSCell when the terminal performs CPA and configuration information 2 of the candidate PSCell when the terminal performs CPC may be collectively referred to as configuration information associated with the candidate PSCell (or referred to as conditional handover configuration information of the conditional handover target cell). A configuration 1 of the candidate PSCell when the terminal performs CPA and a configuration 2 of the candidate PSCell when the terminal performs CPC may be collectively referred to as a configuration of the candidate PSCell (that is, the configuration parameter 2 mentioned above: the configuration information of the conditional handover target cell). The configuration information associated with the candidate PSCell includes a configuration (that is, the configuration parameter 2 mentioned above) of the candidate PSCell and a PSCell addition/change condition (that is, the configuration parameter 3 mentioned above) associated with the candidate PSCell. When the terminal performs CPA, the configuration of the candidate PSCell is used by the terminal device to communicate with the candidate PSCell when the terminal device prepares to add the candidate PSCell. The candidate PSCell addition/change condition includes a candidate PSCell addition condition, and the candidate PSCell addition condition is used by the terminal device to determine whether to add the candidate PSCell. When the terminal performs CPC, the configuration of the candidate PSCell is used by the terminal device to communicate with the candidate PSCell when the terminal device prepares to change a source PSCell to the candidate PSCell. The candidate PSCell addition/change condition includes a candidate PSCell change condition, and the candidate PSCell change condition is used by the terminal device to determine whether to change the source PSCell to the candidate PSCell.

When the terminal device 503 receives a configuration and an addition/change condition of the one or more candidate PSCells but does not detect a PSCell that meets the addition/change condition, the terminal device 503 may be further handed over from a current MN to a target MN with better signal quality. For example, the terminal device 503 may be handed over from the network device 501 to the network device 505. Usually, after the terminal device 503 performs MN handover, the current MN releases one or more candidate PSCells configured for the terminal device 503. After the target MN establishes an RRC connection to the terminal device 503, the target MN may configure one or more candidate PSCells for the terminal device 503 and send, to the terminal device 503, configuration information of the one or more candidate PSCells configured by the target MN for the terminal, for the terminal to perform CPAC. The configuration information of the one or more candidate PSCells configured by the target MN for the terminal includes a configuration and an addition/change condition of the candidate PSCell.

As described above, for conditional handover in any scenario, after the terminal device succeeds in performing conditional handover based on the conditional handover configuration information provided by the network device, the terminal device releases (or deletes) the corresponding conditional handover configuration information. When the terminal device needs to perform a next conditional handover, the network device needs to provide conditional handover configuration information for the terminal device again. As a result, overheads required by the network device for transmitting the conditional handover configuration information are increased. However, it is unnecessary for the network device to provide conditional handover configuration information for the terminal device again in each round of conditional handover of the terminal device. In some cases, the same conditional handover configuration information may be used by the terminal device to perform conditional handover. For example, when the terminal device is moved with small coverage, different rounds of conditional handover of the terminal device are the same in configuration content of used conditional handover configuration information.

Therefore, to reduce overheads occupied for transmitting the conditional handover configuration information, a consecutive conditional handover process may be used. In other words, the terminal device may perform a plurality of rounds of conditional handover based on conditional handover configuration information configured by the network device at one time. In this way, it is unnecessary for the network device to provide conditional handover configuration information for the terminal device again in each round of conditional handover. This is conducive to reducing the overheads occupied for transmitting the conditional handover configuration information.

In some implementations, the terminal device may perform a plurality of rounds of conditional handover based on the same conditional handover configuration information within a period of time. The period of time may be predefined or may be preconfigured. In some other implementations, in a case that a first condition is met, the terminal device may perform a plurality of rounds of conditional handover based on the same conditional handover configuration information. The first condition may be, for example, that a moving range of the terminal device is less than a threshold. Certainly, content of the first condition is not specifically limited in embodiments of this application. In addition, the foregoing first condition may be configured by a network, or the foregoing first condition may be predefined.

It should be noted that in the foregoing consecutive conditional handover process, the conditional handover configuration information used by the terminal device may be understood as being configured by a historical serving cell of the terminal device. The historical serving cell is a serving cell to which the terminal device is currently connected, or a cell that provides a service for the terminal device prior to a serving cell to which the terminal device is currently connected.

In addition, when the terminal device performs conditional handover based on the conditional handover configuration information, if the terminal device fails to access the conditional handover target cell, the terminal device may not delete the foregoing conditional handover configuration information, but continue to execute the handover condition evaluation task related to the conditional handover, so as to continue to evaluate whether a conditional handover event that is associated with the conditional handover target cell and included in the conditional handover configuration information is met. For example, in a scenario of fast recovery of a connection to a cell after a failure of conditional handover of the terminal device, although the conditional handover fails, the terminal device may attempt to recover a connection to a PCell or a PSCell by using one conditional handover target cell instead of executing a reconstruction procedure because the terminal device still stores the configuration information of the one or more conditional handover target cells.

It should be noted that in the foregoing scenario in which the terminal device fails to access the conditional handover target cell, the conditional handover configuration information used by the terminal device may be understood as being configured by a historical serving cell of the terminal device. The historical serving cell is a serving cell to which the terminal device is currently connected, or a cell that provides a service for the terminal device prior to a serving cell to which the terminal device is currently connected.

In either the foregoing described consecutive conditional handover scenario or the foregoing described scenario in which the terminal device fails to access the conditional handover target cell, if the terminal device does not delete the stored conditional handover configuration information, the terminal device needs to further consider how to execute a subsequent handover condition evaluation task related to conditional handover, to evaluate whether a conditional handover event that is associated with one or more conditional handover cells and included in the conditional handover configuration information is met and determine, based on an evaluation result, whether to perform handover to a corresponding conditional handover target cell. The terminal device consumes a specific amount of power when the terminal device executes each round of handover condition evaluation task related to conditional handover. If the terminal device constantly executes, based on the stored conditional handover configuration information, the handover condition evaluation task related to the conditional handover, efficiency of the terminal device in executing the handover condition evaluation task related to the conditional handover is reduced, because it is unnecessary to start the handover condition evaluation task related to the conditional handover in some cases.

Therefore, to improve the efficiency of the terminal device in executing the handover condition evaluation task related to the conditional handover, this application provides a communication method. With reference to FIG. 6, the following describes a communication method in an embodiment of this application by using an example in which a terminal device evaluates whether a conditional handover event associated with a first conditional handover target cell is met. The first conditional handover target cell may be understood as one of one or more conditional handover target cells corresponding to conditional handover configuration information. In addition, the one or more conditional handover target cells corresponding to the conditional handover configuration information may be understood as a target cell to which the terminal device may be handed over, that is, the foregoing candidate target cell. The communication method shown in FIG. 6 includes step S610 and/or step S620.

In step S610, if a first condition is met, a terminal device starts a handover condition evaluation task related to conditional handover.

The foregoing handover condition evaluation task related to the conditional handover is used to evaluate whether a conditional handover event associated with a first conditional handover target cell is met.

It should be noted that, in the foregoing consecutive conditional handover scenario, the foregoing first conditional handover target cell may be understood as one conditional handover target cell to which the terminal device is handed over after the terminal device performs at least one time of conditional handover based on the conditional handover configuration information. In a scenario in which the terminal device fails to access a conditional handover target cell, the foregoing first conditional handover target cell may be understood as a PCell or a PSCell to which the terminal device attempts, based on the conditional handover configuration information, to recover a connection. In general, a difference of the foregoing first conditional handover target cell in the foregoing two scenarios may be understood as follows: In the consecutive conditional handover scenario, the terminal device succeeds in handover to the first conditional handover target cell through the conditional handover. In other words, in the consecutive conditional handover scenario, the terminal device succeeds in accessing the first conditional handover target cell.

It should be understood that, in the consecutive conditional handover scenario, because the conditional handover configuration information stored in the terminal device is not deleted after the conditional handover succeeds, the conditional handover configuration information can be reused by the terminal device. In this way, a network device configures the conditional handover configuration information once, and the terminal device can perform conditional handover a plurality of times.

In the scenario of failing to access the conditional handover target cell, the network device configures the conditional handover configuration information once, and the terminal device can perform conditional handover a plurality of times. In this way, the following case is avoided: The terminal device recovers a connection to a PCell or a PSCell by using a connection re-establishment process or a connection reconfiguration process after the terminal device fails in conditional handover once, resulting in a relatively large delay in recovering a connection to the PCell or the PSCell by the terminal device. In the foregoing scenario, the terminal device may attempt to directly recover a connection to the PCell or the PSCell based on the stored conditional handover configuration information. In this way, the terminal device can quickly recover a connection to the PCell or the PSCell, and the network device is unnecessary to frequently send a reconfiguration message.

In step S620, if a second condition is met, the terminal device stops or skips starting a handover condition evaluation task related to conditional handover.

That if the second condition is met, the terminal device stops the handover condition evaluation task related to the conditional handover may be understood as follows: The terminal device originally starts (or executes) the handover condition evaluation task related to the conditional handover, but then the terminal device no longer executes the handover condition evaluation task related to the conditional handover because the second condition is met. In other words, in a period of time before the second condition is met, the terminal device executes the handover condition evaluation task related to the conditional handover. When the second condition is met, the terminal device stops the handover condition evaluation task related to the conditional handover.

That if the second condition is met, the terminal device skips starting the handover condition evaluation task related to the conditional handover may be understood as follows: Before the second condition is met, the terminal device does not start the handover condition evaluation task related to the conditional handover. In addition, after the second condition is met, the terminal device skips starting the handover condition evaluation task related to the conditional handover.

It should be noted that the foregoing step S610 and step S620 may be used separately. For example, in a case that the first condition is met, the terminal device starts the handover condition evaluation task related to the conditional handover. Otherwise, in a case that the first condition is not met, the terminal device stops or skips starting the handover condition evaluation task related to the conditional handover. For another example, in a case that the second condition is met, the terminal device stops or skips starting the handover condition evaluation task related to the conditional handover. In a case that the second condition is not met, the terminal device starts the handover condition evaluation task related to the conditional handover. Certainly, as described above, the foregoing steps S610 and step S620 may be alternatively used in combination.

In this embodiment of this application, if the first condition is met, the terminal device starts the handover condition evaluation task related to the conditional handover; and/or if the second condition is met, the terminal device stops or skips starting the handover condition evaluation task related to the conditional handover. In other words, the terminal device may determine, based on the first condition and/or the second condition, to start or skip starting (or stop) the handover condition evaluation task related to the conditional handover. In this way, the terminal device is prevented from constantly executing the handover condition evaluation task related to the conditional handover, which is conducive to reducing power consumed by the terminal device in executing the handover condition evaluation task related to the conditional handover, thereby improving efficiency of the terminal device in executing the handover condition evaluation task.

The following describes possible implementations of the first condition applicable to this embodiment of this application. It should be noted that the following listed implementations of the first condition may be used separately or in combination. This is not limited in this embodiment of this application.

Implementation 1: The first condition includes that the terminal device succeeds in receiving a reconfiguration message (also referred to as a “first reconfiguration message”) sent by the network device.

The first reconfiguration message may carry conditional handover configuration information, or may not carry conditional handover configuration information. For ease of differentiation, conditional handover configuration information in the first reconfiguration message is referred to as “conditional handover configuration information 2”. Correspondingly, conditional handover configuration information originally stored in the terminal device is referred to as “conditional handover configuration information 1”.

In some implementations, the foregoing first reconfiguration message is used to trigger the terminal device to perform handover in time (relative to the conditional handover). In this scenario, the first reconfiguration message does not carry the conditional handover configuration information. When the terminal device succeeds in receiving the first reconfiguration message, the terminal device starts a handover condition evaluation task related to conditional handover.

In some other implementations, the foregoing first reconfiguration message is used to trigger the terminal device to update a configuration of a current serving cell of the terminal device (for example, in a non-handover scenario). Usually, in this case, the first reconfiguration message does not carry the conditional handover configuration information. When the terminal device succeeds in receiving the first reconfiguration message, the terminal device starts the handover condition evaluation task related to the conditional handover.

In some other implementations, the foregoing first reconfiguration message is used to trigger the terminal device to perform an operation related to conditional handover. The operation related to the conditional handover includes at least one of adding conditional handover configuration information, modifying conditional handover configuration information, or deleting conditional handover configuration information. In this scenario, the foregoing first reconfiguration message includes the conditional handover configuration information 2. The conditional handover configuration information 2 included in the first reconfiguration message may be the same as or different from the conditional handover configuration information 1 stored in the terminal device. When the terminal device succeeds in receiving the first reconfiguration message, the terminal device starts the handover condition evaluation task related to the conditional handover.

Implementation 2: The first condition includes that the terminal device fails in handover to a second conditional handover target cell.

The foregoing second conditional handover target cell belongs to at least one conditional handover target cell. In other words, the second conditional handover target cell is one of the at least one conditional handover target cell corresponding to the conditional handover configuration information stored in the terminal device.

That the terminal device fails in handover to the second conditional handover target cell may be caused by one or more of the following reasons: that a handover timer expires, that a quantity of times of random access attempts reaches a maximum quantity of times of retransmissions, and that sending of a handover complete message fails.

If the terminal device needs to access the second conditional handover target cell, the terminal device needs to successfully access the second conditional handover target cell before the handover timer expires. If the terminal device still has not accessed the second conditional handover target cell when the handover timer expires, the terminal device fails to access the second conditional handover target cell. The handover timer may be, for example, a timer T304.

If the terminal device needs to access the second conditional handover target cell, the terminal device needs to initiate random access to the second conditional handover target cell. When the quantity of times of random access attempts initiated by the terminal device reaches the maximum quantity of times of retransmissions, the terminal device fails to access the second conditional handover target cell.

If the terminal device needs to access the second conditional handover target cell, the terminal device needs to send a handover complete message to the second conditional handover target cell, to indicate that handover to the second conditional handover target cell is completed. When the terminal device fails to send the handover complete message to the second conditional handover target cell, it is considered that the terminal device fails to access the second conditional handover target cell.

In this embodiment of this application, there are many reasons why the terminal device fails in handover to the second conditional handover target cell. This is not specifically limited in this embodiment of this application.

In this embodiment of this application, if the implementation 2 of the first condition is met, the terminal device may start the handover condition evaluation task related to the conditional handover. In this way, the terminal device, after a failure of conditional handover, may continue to evaluate an appropriate conditional handover target cell by starting the handover condition evaluation task related to the conditional handover, so as to initiate the conditional handover again, which is conducive to reducing a recovery time of the terminal device after the failure of conditional handover. The following case in the conventional conditional handover mechanism is avoided. In the conventional conditional handover mechanism, after the terminal device fails in handover to a conditional handover target cell, the terminal device needs to initiate a connection re-establishment process or trigger a reconfiguration process of the network device, to recovery a connection of the terminal device to a cell (a cell to which connection is recovered may be a conditional handover cell or an unconditional handover cell, and the recovery of a connection may be recovery of a connection to a PCell, or may be recovery of a connection to a PSCell). As a result, time for recovering a connection to a cell after the terminal device fails in the conditional handover is relatively long.

Implementation 3: The first condition includes that the terminal device succeeds in handover to a third conditional handover target cell.

The foregoing third conditional handover target cell belongs to at least one conditional handover target cell. In other words, the third conditional handover target cell is one of the at least one conditional handover target cell corresponding to the conditional handover configuration information stored in the terminal device.

That the terminal device succeeds in handover to the third conditional handover target cell may be understood as follows: The terminal device may communicate with another communications device (for example, a network device to which the third conditional handover target cell belongs) through the third conditional handover target cell. In some implementations, before a handover timer expires, the terminal device successfully completes a random access procedure with the third conditional handover target cell. This may be understood as that the terminal device succeeds in access to the third conditional handover target cell. In some other implementations, before a handover timer expires, the terminal device successfully completes uplink synchronization with the third conditional handover target cell. This may be understood as that the terminal device succeeds in access to the third conditional handover target cell. In some other implementations, before a handover timer expires, the terminal device successfully sends a reconfiguration complete message to the third conditional handover target cell. This may be understood as that the terminal device succeeds in access to the third conditional handover target cell. In some other implementations, if the terminal device successfully exchanges user data with the third conditional handover target cell, it may be understood that the terminal device succeeds in access to the third conditional handover target cell. In some other implementations, if the terminal device successfully receives a first user data scheduling grant instruction sent by the third conditional handover target cell, it may be understood that the terminal device succeeds in access to the third conditional handover target cell. The foregoing scheduling grant instruction may include a resource configuration of uplink data and/or a resource configuration of downlink data. The resource configuration may include a time-frequency resource configuration.

In this embodiment of this application, when the foregoing implementation 3 of the first condition is met, the terminal device may start the handover condition evaluation task related to the conditional handover. This may include: In a process in which the terminal device attempts to access the third conditional handover target cell, the terminal device is unnecessary to start the handover condition evaluation task related to the conditional handover. After the terminal device succeeds in handover to the third conditional handover target cell, the terminal device starts the handover condition evaluation task related to the conditional handover. The terminal device is prevented from executing, in a process of accessing the third conditional handover target cell, the handover condition evaluation task related to the conditional handover. In this way, implementation complexity of the terminal device in a conditional handover process is reduced (the terminal device is unnecessary to simultaneously execute conditional handover access and the handover condition evaluation task related to the conditional handover).

Implementation 4: The first condition includes that a neighboring cell measurement task of the terminal device is started.

Usually, to assist the terminal device in mobility control, the network device configures neighboring cell measurement for the terminal device in a connected mode. The network device may determine, based on a measurement result reported by the terminal device, whether to send a handover configuration to the terminal device, to configure handover of the terminal device to a neighboring cell. Usually, the terminal device needs to meet a measurement start condition to start (or execute) a neighboring cell measurement task. The measurement start condition may include, for example, that a measurement result (for example, signal quality) that is of a current serving cell and that is measured by the terminal device is less than a threshold.

The foregoing measurement start condition is set to avoid a case, in which a terminal device at a center of a cell performs unnecessary neighboring cell measurement, which results in relatively high power consumption of the terminal device. Therefore, when the foregoing measurement start condition is met, it may be considered that the terminal device is not located at the center of the current serving cell, and the neighboring cell measurement task needs to be executed.

It may be learned from the foregoing described neighboring cell measurement task that when the neighboring cell measurement task of the terminal device is started, it indicates that the current serving cell of the terminal device cannot provide good signal quality for the terminal device. It may also be considered that the terminal device may not be located at the center of the current serving cell in this case. Therefore, to improve communication continuity of the terminal device, in this embodiment of this application, that the neighboring cell measurement task of the terminal device is started may be used as a condition for triggering the terminal device to start the handover condition evaluation task related to the conditional handover.

In this embodiment of this application, based on the foregoing setting of the implementation 4 of the first condition, the terminal device with good signal quality can be prevented from executing the handover condition evaluation task related to the conditional handover, that is, the terminal device at the center of the current serving cell is prevented from executing the handover condition evaluation task related to the conditional handover. This is conducive to improving efficiency of the terminal device in executing the handover condition evaluation related to the conditional handover, and avoiding starting an unnecessary handover condition evaluation task related to conditional handover.

In addition, in this embodiment of this application, that the neighboring cell measurement task of the terminal device is started is used as the first condition, to determine to start the handover condition evaluation task related to the conditional handover. In other words, the measurement start condition, specified in a known communications protocol, of the neighboring cell measurement task is reused as a condition for the terminal device to start the handover condition evaluation task related to the conditional handover. This is conducive to reducing a change, to an existing communications protocol, in application of the method in this embodiment of this application, thereby improving compatibility of the method in this embodiment of this application with an existing communications system.

Implementation 5: A signal measurement result, measured by the terminal device, of a serving cell is less than or equal to a first threshold.

The foregoing signal measurement result may indicate quality of service of a service that is provided by the current serving cell for the terminal device. In some implementations, the foregoing signal measurement result may include a cell-level measurement result and/or a beam-level measurement result. The cell-level measurement result may be understood as a measurement result at a granularity of cell. The beam-level measurement result may be understood as a measurement result at a granularity of beam. In some other implementations, a measurement quantity corresponding to the foregoing signal measurement result may be any one of RSRP, RSRQ, or a SINR.

It should be noted that the foregoing first threshold may be configured for the terminal device in a preconfiguration manner, a default configuration manner, a system broadcast message manner, a dedicated signalling manner, or the like. This is not limited in this embodiment of this application.

In this embodiment of this application, based on the foregoing setting of the implementation 5 of the first condition, the terminal device with a good signal measurement result (for example, good signal quality) can be prevented from starting the handover condition evaluation task related to the conditional handover, that is, the terminal device at the center of the current serving cell is prevented from starting the handover condition evaluation task related to the conditional handover. This is conducive to improving efficiency of the terminal device in executing the handover condition evaluation task related to the conditional handover, and avoiding starting an unnecessary handover condition evaluation task related to conditional handover.

In addition, in this embodiment of this application, that the signal measurement result of the serving cell is less than or equal to the first threshold is used as the first condition, to determine to start the handover condition evaluation task related to the conditional handover. In other words, an independent trigger condition is introduced into a condition for the terminal device to start the handover condition evaluation task related to the conditional handover, which is conducive to improving independence of determining to start the handover condition evaluation task related to the conditional handover.

As described above, the foregoing implementations 1 to 5 of the first condition may be used separately, or may be used in combination. Because there are many possible combinations of the foregoing five implementations of the first condition, for brevity, details are not described below. For ease of understanding, only several combination manners are described below by using examples.

In a combination manner 1, the implementation 1 of the first condition and the implementation 5 of the first condition may be combined. In other words, the first condition includes the implementation 1 and the implementation 5. In this case, in a case that both the implementation 1 of the first condition and the implementation 5 of the first condition are met, the terminal device starts the handover condition evaluation task related to the conditional handover. That both the implementation 1 of the first condition and the implementation 5 of the first condition are met may include that the terminal device succeeds in receiving the first reconfiguration message and the signal measurement result, measured by the terminal device, of the serving cell is less than or equal to the first threshold.

In a combination manner 2, the implementation 3 of the first condition and the implementation 5 of the first condition may be combined. In other words, the first condition includes the implementation 3 and the implementation 5. In this case, in a case that both the implementation 3 of the first condition and the implementation 5 of the first condition are met, the terminal device starts the handover condition evaluation task related to the conditional handover. That both the implementation 3 of the first condition and the implementation 5 of the first condition are met may include that the terminal device succeeds in handover to the third conditional handover target cell and the signal measurement result, measured by the terminal device, of the current serving cell (that is, the third conditional handover target cell) is less than or equal to the first threshold.

The following describes possible implementations of the second condition applicable to this embodiment of this application. It should be noted that the following listed implementations of the second condition may be used separately or in combination. This is not limited in this embodiment of this application.

Implementation 1: The second condition includes that the terminal device succeeds in receiving a reconfiguration message (also referred to as a “second reconfiguration message”) sent by the network device.

The second reconfiguration message may carry conditional handover configuration information, or may not carry conditional handover configuration information. For ease of differentiation, the conditional handover configuration information in the second reconfiguration message is referred to as “conditional handover configuration information 2”. Correspondingly, the conditional handover configuration information originally stored in the terminal device is referred to as “conditional handover configuration information 1”.

Usually, after the terminal device succeeds in receiving the second reconfiguration message, it may be understood as that the conditional handover configuration information stored in the terminal device is invalid or unavailable. In this case, the terminal device may stop or skip starting, based on the stored conditional handover configuration information, the handover condition evaluation task related to the conditional handover.

In some implementations, the foregoing second reconfiguration message is used to trigger the terminal device to perform handover in time (relative to the conditional handover). In this scenario, the second reconfiguration message does not carry the conditional handover configuration information. When the terminal device succeeds in receiving the second reconfiguration message, the terminal device stops or skips starting the handover condition evaluation task related to the conditional handover.

In some other implementations, the foregoing second reconfiguration message is used to trigger the terminal device to update a configuration of a current serving cell of the terminal device (for example, in a non-handover scenario). Usually, in this case, the second reconfiguration message does not carry the conditional handover configuration information. When the terminal device succeeds in receiving the second reconfiguration message, the terminal device stops or skips starting the handover condition evaluation task related to the conditional handover.

In some other implementations, the foregoing second reconfiguration message is used to trigger the terminal device to perform an operation related to conditional handover. The operation related to the conditional handover includes at least one of adding conditional handover configuration information, modifying conditional handover configuration information, or deleting conditional handover configuration information. In this case, the foregoing second reconfiguration message includes the conditional handover configuration information 2. The conditional handover configuration information 2 included in the second reconfiguration message may be the same as or different from the conditional handover configuration information 1 stored in the terminal device. When the terminal device succeeds in receiving the second reconfiguration message, the terminal device stops or skips starting the handover condition evaluation task related to the conditional handover.

Implementation 2: The second condition includes that the terminal device fails in handover to a fourth conditional handover target cell.

The foregoing fourth conditional handover target cell belongs to at least one conditional handover target cell. In other words, the fourth conditional handover target cell is one of the at least one conditional handover target cell corresponding to the conditional handover configuration information stored in the terminal device.

That the terminal device fails in handover to the fourth conditional handover target cell may be caused by one or more of the following reasons: that a handover timer expires, that a quantity of times of random access attempts reaches a maximum quantity of times of retransmissions, and that sending of a handover complete message fails.

If the terminal device needs to access the fourth conditional handover target cell, the terminal device needs to successfully access the fourth conditional handover target cell before the handover timer expires. If the terminal device still has not accessed the fourth conditional handover target cell when the handover timer expires, the terminal device fails to access the fourth conditional handover target cell. The handover timer may be, for example, a timer T304.

If the terminal device needs to access the fourth conditional handover target cell, the terminal device needs to initiate random access to the fourth conditional handover target cell. When the quantity of times of random access attempts initiated by the terminal device reaches the maximum quantity of times of retransmissions, the terminal device fails to access the fourth conditional handover target cell.

If the terminal device needs to access the fourth conditional handover target cell, the terminal device needs to send a handover complete message to the fourth conditional handover target cell, to indicate that handover to the fourth conditional handover target cell is completed. When the terminal device fails to send the handover complete message to the conditional handover target cell, it is considered that the terminal device fails to access the fourth conditional handover target cell.

In this embodiment of this application, there are many reasons why the terminal device fails in handover to the fourth conditional handover target cell. This is not specifically limited in this embodiment of this application.

Implementation 3: The second condition includes that the terminal device succeeds in handover to a fifth conditional handover target cell.

The foregoing fifth conditional handover target cell belongs to at least one conditional handover target cell. In other words, the fifth conditional handover target cell is one of the at least one conditional handover target cell corresponding to the conditional handover configuration information stored in the terminal device.

That the terminal device succeeds in handover to the fifth conditional handover target cell may be understood as follows: The terminal device may communicate with another communications device (for example, a network device to which the fifth conditional handover target cell belongs) through the fifth conditional handover target cell. In some implementations, before a handover timer expires, the terminal device successfully completes a random access procedure with the fifth conditional handover target cell. This may be understood as that the terminal device succeeds in access to the fifth conditional handover target cell. In some other implementations, before a handover timer expires, the terminal device successfully completes uplink synchronization with the fifth conditional handover target cell. This may be understood as that the terminal device succeeds in access to the fifth conditional handover target cell. In some other implementations, before a handover timer expires, the terminal device successfully sends a reconfiguration complete message to the fifth conditional handover target cell. This may be understood as that the terminal device succeeds in access to the fifth conditional handover target cell. In some other implementations, if the terminal device successfully exchanges user data with the fifth conditional handover target cell, it may be understood that the terminal device succeeds in access to the fifth conditional handover target cell. In some other implementations, if the terminal device successfully receives a first user data scheduling grant instruction sent by the fifth conditional handover target cell, it may be understood that the terminal device succeeds in access to the fifth conditional handover target cell. The foregoing scheduling grant instruction may include a resource configuration of uplink data and/or a resource configuration of downlink data. The resource configuration may include a time-frequency resource configuration.

In this embodiment of this application, when the foregoing implementation 3 of the second condition is met, the terminal device stops or skips starting the handover condition evaluation task related to the conditional handover. This is conducive to improving efficiency of the terminal device in executing the handover condition evaluation task related to the conditional handover, and preventing the terminal device from continuously executing the handover condition evaluation task related to the conditional handover immediately after executing conditional handover once.

Implementation 4: The second condition includes that a neighboring cell measurement task of the terminal device is not started.

It may be learned from the neighboring cell measurement task described in the implementation 4 of the first condition that when the neighboring cell measurement task of the terminal device is started, it indicates that the current serving cell of the terminal device cannot provide good signal quality for the terminal device. It may also be considered that the terminal device may not be located at a center of the current serving cell in this case. Otherwise, when the neighboring cell measurement task of the terminal device is not started, it indicates that the current serving cell of the terminal device can provide good signal quality for the terminal device. It may also be considered that the terminal device may be located at a center of the current serving cell in this case. However, such terminal device is unnecessary to perform conditional handover. Therefore, to improve efficiency of the terminal device in executing the handover condition evaluation task related to the conditional handover (to avoid unnecessary handover condition evaluation related to conditional handover), in this embodiment of this application, that the neighboring cell measurement task of the terminal device is not started may be used as a condition for triggering the terminal device to stop or skip starting the handover condition evaluation task related to the conditional handover.

In this embodiment of this application, based on the foregoing setting of the implementation 4 of the second condition, the terminal device with good signal quality can be prevented from executing the handover condition evaluation task related to the conditional handover, that is, the terminal device at the center of the current serving cell is prevented from executing the handover condition evaluation task related to the conditional handover. This is conducive to improving efficiency of the terminal device in executing the handover condition evaluation task related to the conditional handover.

In addition, in this embodiment of this application, that the neighboring cell measurement task of the terminal device is not started is used as the second condition, to determine to stop or skip starting the handover condition evaluation task related to the conditional handover. In other words, a mechanism, specified in a known communications protocol, of the neighboring cell measurement task is reused as a condition for the terminal device to stop or skip starting the handover condition evaluation task related to the conditional handover. This is conducive to reducing a change, to an existing communications protocol, in application of the method in this embodiment of this application, thereby improving compatibility of the method in this embodiment of this application with an existing communications system.

Implementation 5: The second condition includes that a neighboring cell measurement task of the terminal device is stopped.

It may be learned from the neighboring cell measurement task described in the implementation 4 of the first condition that when the neighboring cell measurement task of the terminal device is started, it indicates that the current serving cell of the terminal device cannot provide good signal quality for the terminal device. It may also be considered that the terminal device may not be located at a center of the current serving cell in this case. Otherwise, when the neighboring cell measurement task of the terminal device is stopped, it indicates that the current serving cell of the terminal device can provide good signal quality for the terminal device. It may also be considered that the terminal device may return to the center of the current serving cell in this case. However, such terminal device is unnecessary to perform conditional handover. Therefore, to improve efficiency of the terminal device in executing the handover condition evaluation task related to the conditional handover, in this embodiment of this application, that the neighboring cell measurement task of the terminal device is stopped may be used as a condition for triggering the terminal device to stop or skip starting the handover condition evaluation task related to the conditional handover.

In this embodiment of this application, based on the foregoing setting of the implementation 5 of the second condition, the terminal device with good signal quality can be prevented from executing the handover condition evaluation task related to the conditional handover, that is, the terminal device at the center of the current serving cell is prevented from executing the handover condition evaluation task related to the conditional handover. This is conducive to improving efficiency of the terminal device in executing the handover condition evaluation task related to the conditional handover.

In addition, in this embodiment of this application, that the neighboring cell measurement task of the terminal device is stopped is used as the second condition, to determine to stop or skip starting the handover condition evaluation task related to the conditional handover. In other words, a mechanism, specified in a known communications protocol, of the neighboring cell measurement task is reused as a condition for the terminal device to stop or skip starting the handover condition evaluation task related to the conditional handover. This is conducive to reducing a change, to an existing communications protocol, in application of the method in this embodiment of this application, thereby improving compatibility of the method in this embodiment of this application with an existing communications system.

Implementation 6: The second condition includes that a signal measurement result, measured by the terminal device, of a serving cell is greater than or equal to a second threshold.

The foregoing signal measurement result may indicate service quality of a service that is provided by the current serving cell for the terminal device. In some implementations, the foregoing signal measurement result may include a cell-level measurement result and/or a beam-level measurement result. The cell-level measurement result may be understood as a measurement result at a granularity of cell. The beam-level measurement result may be understood as a measurement result at a granularity of beam. In some other implementations, a measurement quantity corresponding to the foregoing signal measurement result may be any one of RSRP, RSRQ, or a SINR.

It should be noted that the foregoing second threshold may be configured for the terminal device in a preconfiguration manner, a default configuration manner, a system broadcast message manner, a dedicated signalling manner, or the like. This is not limited in this embodiment of this application.

In this embodiment of this application, based on the foregoing setting of the implementation 6 of the second condition, the terminal device with a good signal measurement result (for example, good signal quality) can be prevented from starting the handover condition evaluation task related to the conditional handover, that is, the terminal device at the center of the current serving cell is prevented from starting the handover condition evaluation task related to the conditional handover. This is conducive to improving efficiency of the terminal device in executing the handover condition evaluation task related to the conditional handover.

In addition, in this embodiment of this application, that the signal measurement result of the serving cell is greater than or equal to the second threshold is used as the second condition, to determine to stop or skip starting the handover condition evaluation task related to the conditional handover. In other words, an independent trigger condition is introduced into a condition for the terminal device to stop or skip starting the handover condition evaluation task related to the conditional handover, which is conducive to improving independence of determining to stop or skip starting the handover condition evaluation task related to the conditional handover.

As described above, in some cases, conditional handover configuration information stored in the terminal device corresponds to a plurality of conditional handover target cells. However, not all the plurality of conditional handover target cells are neighboring cells of the current serving cell. One of the plurality of conditional handover target cells may be a neighboring cell of a neighboring cell of the current serving cell, and the terminal device is usually not directly handed over from the current serving cell to such conditional handover target cell. Therefore, to further reduce power required by the terminal device to execute the handover condition evaluation task related to the conditional handover, for a conditional handover event associated with such conditional handover target cell (a neighboring cell of a neighboring cell), the terminal device may not execute a handover condition evaluation task related to conditional handover.

Therefore, to exclude the foregoing conditional handover target cell, in this embodiment of this application, the network device may send first configuration information to the terminal device, to indicate a range of a conditional handover cell on which the handover condition evaluation task related to the conditional handover needs to be executed. Correspondingly, the terminal device may determine, based on the first configuration information, a conditional handover target cell set on which handover condition evaluation needs to be performed. In other words, the foregoing method further includes: The network device sends first configuration information to the terminal device; and correspondingly, the terminal device determines, based on the conditional handover configuration information and the first configuration information, a conditional handover target cell set on which handover condition evaluation needs to be performed when the handover condition evaluation task related to the conditional handover is started. The conditional handover target cell set includes the first conditional handover target cell.

In some implementations, a cell configured in the first configuration information may include a neighboring cell of the current serving cell. Correspondingly, the terminal device may determine, as a conditional handover target cell that belong to the foregoing conditional handover target cell set, a cell that belongs to cells configured in the first configuration information and belongs to the conditional handover cell corresponding to the conditional handover configuration information. In other words, a conditional handover target cell included in the conditional handover target cell set may be understood as a neighboring cell of the current serving cell of the terminal device.

In some implementations, the foregoing first configuration information includes one or more pieces of frequency information of a neighboring cell. In some other implementations, the first configuration information includes at least one piece of physical cell identity PCI information associated with each piece of frequency information in at least one piece of frequency information.

The foregoing first configuration information is used to indicate a neighboring cell of the current serving cell of the terminal device. Therefore, it may be understood that the first configuration information is associated with the current serving cell of the terminal device. In other words, the first configuration information is associated with a configuration of the current serving cell of the terminal device. The first configuration information may be configured by the current serving cell of the terminal device. In some implementations, the first configuration information may be configured by the current serving cell for the terminal device by using a system broadcast message or dedicated signalling. Certainly, the foregoing first configuration information may be alternatively configured by the historical serving cell of the terminal device. This is not limited in this embodiment of this application.

As described above, the terminal device may determine that belonging to the cells configured in the first configuration information and belonging to the conditional handover cell corresponding to the conditional handover configuration information, as a condition of being a conditional handover target cell belonging to the foregoing conditional handover target cell set. In other words, second configuration information associated with the conditional handover target cell in the conditional handover target cell set matches the first configuration information, that is, the second configuration information associated with the conditional handover target cell in the conditional handover target cell set is partially or completely the same as the first configuration information.

The foregoing describes content of information included in the first configuration information. Correspondingly, the second configuration information associated with the conditional handover target cell may include the frequency information of the conditional handover target cell in the conditional handover target cell set. Certainly, the second configuration information associated with the conditional handover target cell may further include PCI of the conditional handover target cell in the conditional handover target cell set. In this case, that the first configuration information matches the second configuration information associated with the conditional handover target cell may be understood as the following several cases.

In a case 1, if the first configuration information includes frequency information of a neighboring cell and the second configuration information associated with the conditional handover target cell includes frequency information of a conditional handover target cell, that the first configuration information matches the second configuration information associated with the conditional handover target cell includes that the frequency information of the neighboring cell is the same as the frequency information of the conditional handover target cell.

In a case 2, if the first configuration information includes frequency information of a neighboring cell and a PCI associated with a frequency of the neighboring cell, and the second configuration information associated with the conditional handover target cell includes frequency information of a conditional handover target cell, that the first configuration information matches the second configuration information associated with the conditional handover target cell includes that the frequency information, in the first configuration information, of the neighboring cell is the same as the frequency information, in the second configuration information associated with the conditional handover target cell, of the conditional handover target cell.

In a case 3, if the first configuration information includes frequency information of a neighboring cell and a PCI associated with a frequency of the neighboring cell, and the second configuration information associated with the conditional handover target cell includes frequency information of a conditional handover target cell and a PCI associated with a frequency of the conditional handover target cell, that the first configuration information matches the second configuration information associated with the conditional handover target cell includes that the frequency information, in the first configuration information, of the neighboring cell and the PCI, in the first configuration information, associated with the frequency of the neighboring cell are the same as the frequency information, in the second configuration information associated with the conditional handover target cell, of the conditional handover target cell and the PCI, in the second configuration information associated with the conditional handover target cell, associated with the frequency of the conditional handover target cell.

The foregoing describes the manners of determining a conditional handover target cell set. Therefore, for a conditional handover target cell, in the conditional handover configuration information, that does not belong to the conditional handover target cell set, the terminal device does not evaluate whether a conditional handover event associated with such conditional handover target cell is met. In the following, for the conditional handover target cell, in the conditional handover configuration information, that does not belong to the conditional handover target cell set, it may be understood that second configuration information of such conditional handover target cell does not match the first configuration information. The following uses a sixth conditional handover target cell corresponding to the conditional handover configuration information as an example for description. The sixth conditional handover target cell is one of the at least one conditional handover target cell corresponding to the conditional handover configuration information. It is assumed that the conditional handover configuration information includes second configuration information of the sixth conditional handover target cell, and all or a part of information in the second configuration information of the sixth conditional handover target cell does not match the first configuration information. In this case, the terminal device does not evaluate whether a conditional handover event associated with the sixth conditional handover target cell is met.

In some implementations, the second configuration information of the sixth conditional handover target cell includes frequency information of the sixth conditional handover target cell. In some other implementations, the second configuration information of the sixth conditional handover target cell includes a PCI associated with frequency information of the sixth conditional handover target cell.

In this embodiment of this application, the foregoing first configuration information may belong to information in a neighboring cell frequency configuration, or the first configuration information may be a neighboring cell frequency configuration. In this case, the first configuration information may be configured by using a system broadcast message of the current serving cell of the terminal device.

For example, the conditional handover configuration information stored by the terminal device corresponds to five conditional handover target cells, and cell frequencies correspondingly used by the five conditional handover target cells are respectively f1, f2, f3, f4, and f5. A cell frequency correspondingly used by the current serving cell of the terminal device is f0, and neighboring cell frequencies included in neighboring cell frequency information (that is, the first configuration information) of the current serving cell are f1, f2, and f3. In other words, conditional handover target cells corresponding to frequencies are f1, f2, and f3 form a conditional handover target cell set.

In this case, if the first condition is met, it is unnecessary for the terminal device to start the handover condition evaluation task related to the conditional handover to evaluate conditional handover events associated with the five conditional handover target cells, because conditional handover target cells whose frequencies are f4 and f5 are not neighboring cells of the current serving cell and neighboring cells of the current serving cell may include only the conditional handover target cells corresponding to f1, f2, and f3. Therefore, the terminal device may evaluate, by using the handover condition evaluation task related to the conditional handover, conditional handover events associated with the conditional handover target cells corresponding to f1, f2, and f3.

It is assumed that the conditional handover configuration information corresponding to the five conditional handover target cells is valid, the terminal device is handed over from the cell corresponding to the frequency f0 to the cell corresponding to the frequency f1, and neighboring cell frequencies included in neighboring cell frequency information of the serving cell corresponding to the f1 are f2, f3, and f4. In this case, if the first condition is met, the terminal device starts the handover condition evaluation task related to the conditional handover to evaluate conditional handover events associated with the conditional handover target cells corresponding to frequencies f2, f3, and f4.

For another example, the conditional handover configuration information stored by the terminal device corresponds to five conditional handover target cells, and cell frequencies and PCIs that are correspondingly used by the five conditional handover target cells are respectively {f1, PCI2}, {f2, PCI3}, {f3, PCI4}, {f4, PCI5}, and {f5, PCI6}. A cell frequency correspondingly used by the current serving cell of the terminal device is f0, and frequencies and PCIs, included in the neighboring cell frequency information (that is, the foregoing first configuration information) of the current serving cell, of neighboring cells are respectively {f1, {PCI1, PCI2, PCI3}}, {f2, {PCI1, PCI2, PCI3}}, and {f3, {PCI1, PCI2, PCI3}}. In this case, frequencies and PCIs that correspond to conditional handover target cells included in the conditional handover target cell set are respectively {f1, PCI2}, and {f2, PCI3}.

In this case, a neighboring cell of the current serving cell does not include a cell corresponding to {f3, PCI4}, and the frequencies f4 and f5 are not neighboring cell frequencies of the current serving cell. Therefore, in a case that the first condition is met, the terminal device may start the handover condition evaluation task related to the conditional handover, to evaluate a conditional handover event associated with a conditional handover target cell in the conditional handover target cell set and ignore evaluation of conditional handover events associated with the conditional handover target cells corresponding to frequencies are f3, f4, and f5.

In this embodiment of this application, the foregoing first configuration information may be alternatively configured by using dedicated signalling. In this case, the first configuration information may also be referred to as “measurement limitation configuration”.

For example, the conditional handover configuration information stored by the terminal device corresponds to five conditional handover target cells, and cell frequencies correspondingly used by the five conditional handover target cells are respectively f1, f2, f3, f4, and f5. A cell frequency correspondingly used by the current serving cell of the terminal device is f1, and neighboring cell frequencies included in a measurement limitation configuration (that is, the first configuration information) of the current serving cell are f2, f3, and f4. In other words, conditional handover target cells corresponding to frequencies are f2, f3, and f4 form a conditional handover target cell set.

In this case, if the first condition is met, it is unnecessary for the terminal device to start the handover condition evaluation task related to the conditional handover to evaluate conditional handover events associated with the five conditional handover target cells, because a conditional handover target cell whose frequency is f5 is not a neighboring cell of the current serving cell and neighboring cells of the current serving cell may include only the conditional handover target cells corresponding to f2, f3, and f4. Therefore, the terminal device may evaluate, by using the handover condition evaluation task related to the conditional handover, conditional handover events associated with the conditional handover target cells corresponding to f2, f3, and f4.

For another example, the conditional handover configuration information stored by the terminal device corresponds to five conditional handover target cells, and cell frequencies and PCIs that are correspondingly used by the five conditional handover target cells are respectively {f1, PCI2}, {f2, PCI3}, {f3, PCI4}, {f4, PCI5}, and {f5, PCI6}. A cell frequency correspondingly used by the current serving cell of the terminal device is f1, and frequencies and PCIs, included in the measurement limitation configuration of the current serving cell, of neighboring cells, are respectively {f2, {PCI1, PCI2, PCI3}}, {f3, {PCI1, PCI2, PCI3}}, and {f4, {PCI1, PCI2, PCI3}}. In this case, a frequency and a PCI that correspond to a conditional handover target cell included in the conditional handover target cell set are {f2, PCI3}.

In this case, neighboring cells of the current serving cell do not include cells corresponding to {f1, PCI2}, {f3, PCI4}, and {f4, PCI5}, and the frequency f5 is not a neighboring cell frequency of the current serving cell. Therefore, in a case that the first condition is met, the terminal device may start the handover condition evaluation task related to the conditional handover, to evaluate a conditional handover event associated with a conditional handover target cell in the conditional handover target cell set and ignore evaluation of conditional handover events associated with the conditional handover target cells corresponding to frequencies f1, f3, f4, and f5.

It should be noted that if the current serving cell of the terminal device corresponds to a valid measurement limitation configuration, the terminal device may determine the conditional handover target cell set based on the measurement limitation configuration. If the current serving cell of the terminal device does not correspond to a valid measurement limitation configuration (for example, a target cell to which the terminal device is handed over (that is, the current serving cell of the terminal device) is not a conditional handover target cell), the terminal device may determine the conditional handover target cell set based on the neighboring cell frequency configuration of the serving cell.

Certainly, in this embodiment of this application, the foregoing first configuration information may alternatively indicate a conditional handover target cell, in the one or more conditional handover cells corresponding to the conditional handover configuration information, on which evaluation of whether a handover condition is met does not need to be performed. Specific content of the foregoing first configuration information is not limited in this embodiment of this application.

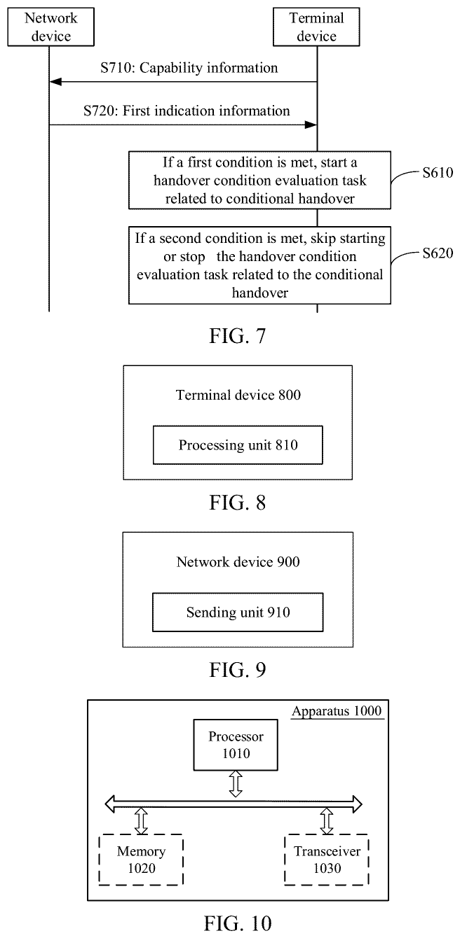

With increasingly wide application of communications systems, more types of terminal devices are included, and these types of terminal devices are different in capabilities. Therefore, in this embodiment of this application, the terminal device may be configured to report a terminal device capability to the network device before performing the method shown in FIG. 6. With reference to FIG. 7, the foregoing method further includes step S710. In step S710, the terminal device sends capability information to the network device. The capability information is used to indicate one or more of the following terminal capabilities: whether the terminal device supports: if a first condition is met, starting a handover condition evaluation task; whether the terminal device supports: if a second condition is met, stopping or skipping starting the handover condition evaluation task; and whether the terminal device supports: determining a conditional handover target cell set based on conditional handover configuration information and first configuration information. Step S710 is an optional step.

In some cases, the foregoing method shown in FIG. 6 may be used as an optional conditional handover mechanism. Correspondingly, the network device may determine whether it is necessary for the terminal device to perform the method shown in FIG. 6. For example, for a terminal device with sufficient power or a terminal device featured by conveniently charging, the network device may indicate that such terminal device does not apply the method shown in FIG. 6. However, for a terminal device with insufficient power or a terminal device featured by inconvenient charging, the network device may indicate that the terminal device applies the method shown in FIG. 6. With reference to FIG. 7, before the method shown in FIG. 6, the foregoing method further includes step S720. In step S720, the network device sends first indication information to the terminal device. Step S720 is an optional step.

The first indication information is used to indicate one or more of the following information: whether the terminal device enables: if a first condition is met, starting the handover condition evaluation task; whether the terminal device enables: if a second condition is met, stopping or skipping starting the handover condition evaluation task; and whether the terminal device enables: determining the conditional handover target cell set based on the conditional handover configuration information and the first configuration information.

It should be noted that, in this embodiment of this application, the foregoing solution in which the terminal device sends the capability information and the solution in which the network device sends the indication information may be used separately, or may be used in combination. In a case that the solution in which the terminal device sends the capability information and the solution in which the network device sends the indication information are used in combination, an order of sending the capability information and sending the indication information is not limited in this embodiment of this application. In some implementations, the terminal device may first send the capability information. Correspondingly, the network device may send the indication information to the terminal device based on the received capability information.

The foregoing describes method embodiments of this application in detail with reference to FIG. 1 to FIG. 7. The following describes apparatus embodiments of this application in detail with reference to FIG. 8 to FIG. 10. It should be understood that the descriptions of the method embodiments correspond to descriptions of the apparatus embodiments. Therefore, for parts that are not described in detail, reference may be made to the foregoing method embodiments.

FIG. 8 is a diagram of a terminal device according to an embodiment of this application. The terminal device shown in FIG. 8 includes a processing unit 810.

The processing unit 810 is configured to, if a first condition is met, start a handover condition evaluation task related to conditional handover; and/or

The processing unit 810 is further configured to, if a second condition is met, stop or skip starting the handover condition evaluation task related to the conditional handover.

The handover condition evaluation task related to the conditional handover is used to evaluate whether a conditional handover event associated with a first conditional handover target cell is met. The first conditional handover target cell is one of at least one conditional handover target cell corresponding to conditional handover configuration information configured by a network device. The conditional handover configuration information configured by the network device includes configuration information corresponding to the at least one conditional handover target cell.

In a possible implementation, the conditional handover configuration information configured by the network device is configured by a current serving cell of the terminal device or configured by a historical serving cell of the terminal device.

In a possible implementation, the first condition includes one or more of the following conditions: that the terminal device succeeds in receiving a first reconfiguration message sent by the network device; that the terminal device fails in handover to a second conditional handover target cell, where the second conditional handover target cell belongs to the at least one conditional handover target cell; that the terminal device succeeds in handover to a third conditional handover target cell, where the third conditional handover target cell belongs to the at least one conditional handover target cell; that a neighboring cell measurement task of the terminal device is started; or that a signal measurement result, measured by the terminal device, of a serving cell is less than or equal to a first threshold.

In a possible implementation, the second condition includes one or more of the following conditions: that the terminal device succeeds in receiving a second reconfiguration message sent by the network device; that the terminal device fails in handover to a fourth conditional handover target cell, where the fourth conditional handover target cell belongs to the at least one conditional handover target cell; that the terminal device succeeds in handover to a fifth conditional handover target cell, where the fifth conditional handover target cell belongs to the at least one conditional handover target cell; that a neighboring cell measurement task of the terminal device is not started; that a neighboring cell measurement task of the terminal device is stopped; or that a signal measurement result, measured by the terminal device, of a serving cell is greater than or equal to a second threshold.

In a possible implementation, a first receiving unit is configured to receive first configuration information sent by the network device. The processing unit is configured to determine, based on the conditional handover configuration information and the first configuration information, a conditional handover target cell set on which handover condition evaluation needs to be performed when the handover condition evaluation task related to the conditional handover is started. The conditional handover target cell set includes the first conditional handover target cell.

In a possible implementation, the first configuration information includes at least one piece of frequency information of a neighboring cell.

In a possible implementation, the first configuration information includes at least one piece of physical cell identity PCI information associated with each piece of frequency information in the at least one piece of frequency information.

In a possible implementation, the first configuration information is associated with a current serving cell of the terminal device.

In a possible implementation, the first configuration information is configured in at least one of the following manners: a predefined manner, a default configuration manner, a system broadcast message manner, and a dedicated signalling manner.

In a possible implementation, second configuration information associated with a conditional handover target cell in the conditional handover target cell set matches the first configuration information.

In a possible implementation, the conditional handover configuration information includes second configuration information of a sixth conditional handover target cell, all or a part of information in the second configuration information of the sixth conditional handover target cell does not match the first configuration information, and the terminal device does not evaluate whether a conditional handover event associated with the sixth conditional handover target cell is met.

In a possible implementation, the second configuration information of the sixth conditional handover target cell includes frequency information of the sixth conditional handover target cell.

In a possible implementation, the second configuration information of the sixth conditional handover target cell includes a PCI associated with frequency information of the sixth conditional handover target cell.

In a possible implementation, a second receiving unit is configured to receive first indication information sent by the network device. The first indication information is used to indicate one or more of the following information: whether the terminal device enables: if the first condition is met, starting the handover condition evaluation task related to the conditional handover; whether the terminal device enables: if the second condition is met, stopping or skipping starting the handover condition evaluation task related to the conditional handover; and whether the terminal device enables: determining the conditional handover target cell set based on the conditional handover configuration information and the first configuration information.

In a possible implementation, a sending unit is configured to send capability information to the network device. The capability information is used to indicate one or more of the following terminal capabilities: whether the terminal device supports: if the first condition is met, starting the handover condition evaluation task related to the conditional handover; whether the terminal device supports: if the second condition is met, stopping or skipping starting the handover condition evaluation task related to the conditional handover; and whether the terminal device supports: determining the conditional handover target cell set based on the conditional handover configuration information and the first configuration information.

In a possible implementation, the at least one conditional handover target cell includes a primary cell PCell or a primary secondary cell PSCell that is configured for the terminal device.

FIG. 9 is a schematic diagram of a network device according to an embodiment of this application. The network device shown in FIG. 9 includes a sending unit 910.

The sending unit 910 is configured to send a reconfiguration message to a terminal device. The reconfiguration message is used to instruct the terminal device to start a handover condition evaluation task related to conditional handover, and/or the reconfiguration message is used to instruct the terminal device to stop or skip starting the handover condition evaluation task related to the conditional handover. The handover condition evaluation task related to the conditional handover is used to evaluate whether a conditional handover event associated with a first conditional handover target cell is met. The first conditional handover target cell is one of at least one conditional handover target cell corresponding to conditional handover configuration information configured by the network device. The conditional handover configuration information configured by the network device includes configuration information corresponding to the at least one conditional handover target cell.

In a possible implementation, the conditional handover configuration information configured by the network device is configured by a current serving cell of the terminal device or configured by a historical serving cell of the terminal device.

In a possible implementation, the sending unit is further configured to send first configuration information to the terminal device. The first configuration information is used to determine a conditional handover target cell set. The conditional handover target cell set includes a conditional handover target cell, where the conditional handover target cell is associated with a conditional handover event and handover condition evaluation needs to be performed on the conditional handover target cell when the handover condition evaluation task related to the conditional handover is started. The conditional handover target cell set includes the first conditional handover target cell.

In a possible implementation, the first configuration information includes at least one piece of frequency information of a neighboring cell.

In a possible implementation, the first configuration information includes at least one piece of physical cell identity PCI information associated with each piece of frequency information in the at least one piece of frequency information.

In a possible implementation, the first configuration information is associated with a current serving cell of the terminal device.

In a possible implementation, the first configuration information is configured in at least one of the following manners: a predefined manner, a default manner, a system broadcast message manner, and a dedicated signalling manner.

In a possible implementation, second configuration information associated with a conditional handover target cell in the conditional handover target cell set matches the first configuration information.

In a possible implementation, the conditional handover configuration information includes second configuration information of a sixth conditional handover target cell, all or a part of information in the second configuration information of the sixth conditional handover target cell does not match the first configuration information, and the terminal device does not evaluate whether a conditional handover event associated with the sixth conditional handover target cell is met.

In a possible implementation, the second configuration information of the sixth conditional handover target cell includes frequency information of the sixth conditional handover target cell.

In a possible implementation, the second configuration information of the sixth conditional handover target cell includes a PCI associated with frequency information of the sixth conditional handover target cell.

In a possible implementation, the sending unit is configured to send first indication information to the terminal device. The first indication information is used to indicate one or more of the following information: whether the terminal device enables: if a first condition is met, starting the handover condition evaluation task related to the conditional handover; whether the terminal device enables: if a second condition is met, stopping or skipping starting the handover condition evaluation task related to the conditional handover; and whether the terminal device enables: determining the conditional handover target cell set based on the conditional handover configuration information and the first configuration information.

In a possible implementation, a receiving unit is configured to receive capability information sent by the terminal device. The capability information is used to indicate one or more of the following terminal capabilities: whether the terminal device supports: if the first condition is met, starting the handover condition evaluation task related to the conditional handover; whether the terminal device supports: if the second condition is met, stopping or skipping starting the handover condition evaluation task related to the conditional handover; and whether the terminal device supports: determining the conditional handover target cell set based on the conditional handover configuration information and the first configuration information.

In a possible implementation, the first condition includes one or more of the following conditions: that the terminal device succeeds in receiving the reconfiguration message; that the terminal device fails in handover to a second conditional handover target cell, where the second conditional handover target cell belongs to the at least one conditional handover target cell; that the terminal device succeeds in handover to a third conditional handover target cell, where the third conditional handover target cell belongs to the at least one conditional handover target cell; that a neighboring cell measurement task of the terminal device is started; or that a signal measurement result, measured by the terminal device, of a serving cell is less than or equal to a first threshold.

In a possible implementation, the second condition includes one or more of the following conditions: that the terminal device succeeds in receiving the reconfiguration message; that the terminal device fails in handover to a fourth conditional handover target cell, where the fourth conditional handover target cell belongs to the at least one conditional handover target cell; that the terminal device succeeds in handover to a fifth conditional handover target cell, where the fifth conditional handover target cell belongs to the at least one conditional handover target cell; that a neighboring cell measurement task of the terminal device is not started; that a neighboring cell measurement task of the terminal device is stopped; or that a signal measurement result, measured by the terminal device, of a serving cell is greater than or equal to a second threshold.

In a possible implementation, the at least one conditional handover target cell includes a primary cell PCell or a primary secondary cell PSCell that is configured for the terminal device.

FIG. 10 is a schematic structural diagram of a communications apparatus according to an embodiment of this application. Dashed lines in FIG. 10 indicate that units or modules are optional. The apparatus 1000 may be configured to implement the methods described in the foregoing method embodiments. The apparatus 1000 may be a chip, a terminal device, or a network device.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program. The program may be executed by the processor 1010, to cause the processor 1010 to perform the methods described in the foregoing method embodiments. The memory 1020 may be independent of the processor 1010 or may be integrated into the processor 1010.

The apparatus 1000 may further include a transceiver 1030. The processor 1010 may communicate with another device or chip through the transceiver 1030. For example, the processor 1010 may transmit data to and receive data from another device or chip through the transceiver 1030.

An embodiment of this application further provides a computer-readable storage medium for storing a program. The computer-readable storage medium may be applied to the terminal device or the network device provided in embodiments of this application, and the program causes a computer to perform the methods, performed by the terminal device or the network device, in various embodiments of this application.

An embodiment of this application further provides a computer program product. The computer program product includes a program. The computer program product may be applied to the terminal device or the network device provided in embodiments of this application, and the program causes a computer to perform the methods, performed by the terminal device or the network device, in various embodiments of this application.

An embodiment of this application further provides a computer program. The computer program may be applied to the terminal device or the network device provided in embodiments of this application, and the computer program causes a computer to perform the methods, performed by the terminal device or the network device, in various embodiments of this application.

It should be understood that meanings of the foregoing mentioned serving cell (or the current serving cell) slightly vary with scenarios. In a CHO scenario or a conditional PCell change scenario, the serving cell may be a PCell currently connected to the terminal device, for example, may include a PCell connected to the terminal device after the terminal device performs conditional handover. For another example, the serving cell may alternatively include a PCell connected to the terminal device before the terminal device performs conditional handover.

In a CPA scenario or a conditional PSCell addition scenario, the serving cell may be a PSCell currently connected to the terminal device, for example, may include a PSCell connected to the terminal device after the terminal device performs conditional handover. For another example, the serving cell may alternatively include a PSCell connected to the terminal device before the terminal device performs conditional handover.

In a CPC scenario or a conditional PSCell cell change scenario, the serving cell may be a PSCell currently connected to the terminal device, for example, may include a PSCell connected to the terminal device after the terminal device performs conditional handover. For another example, the serving cell may alternatively include a PSCell connected to the terminal device before the terminal device performs conditional handover.

In a CHO and CPA combination configuration scenario or in a CHO and CPC combination configuration scenario, the serving cell may include a PCell and a PSCell that are currently connected to the terminal device. For example, the serving cell may include a PCell and a PSCell that are connected to the terminal device after the terminal device performs conditional handover. For another example, the serving cell may alternatively include a PCell and a PSCell that are connected to the terminal device before the terminal device performs conditional handover.

It should be further understood that the terms “system” and “network” in this application may be used interchangeably. In addition, the terms used in this application are merely used to explain the specific embodiments of this application, and are not intended to limit this application. In the specification, claims, and accompanying drawings of this application, the terms “first”, “second”, “third”, “fourth”, and the like are intended to distinguish between different objects but do not indicate a particular order. In addition, the terms “include” and “have” and any variations thereof are intended to cover a non-exclusive inclusion.

The “indication” mentioned in embodiments of this application may be a direct indication or an indirect indication, or indicate an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefining” or “preconfiguring” may be implemented by pre-storing corresponding codes or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship for describing associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution orders. The execution orders of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the embodiments are implemented by software, the embodiments may be completely or partially implemented in a form of a computer program product. The computer program product includes one or more computer instructions. When the computer program instructions are loaded and executed on a computer, the procedures or functions in embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, microwave, and the like) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
if a first condition is met, starting, by a terminal device, a handover condition evaluation task related to conditional handover; and/or
if a second condition is met, stopping or skipping starting, by the terminal device, the handover condition evaluation task related to the conditional handover,
wherein the handover condition evaluation task related to the conditional handover is used to evaluate whether a conditional handover event associated with a first conditional handover target cell is met, the first conditional handover target cell is one of at least one conditional handover target cell corresponding to conditional handover configuration information configured by a network device, and the conditional handover configuration information configured by the network device comprises configuration information corresponding to the at least one conditional handover target cell.

2. The method according to claim 1, wherein the conditional handover configuration information configured by the network device is configured by a current serving cell of the terminal device or configured by a historical serving cell of the terminal device.

3. The method according to claim 1, wherein the first condition comprises one or more of following conditions:
that the terminal device succeeds in receiving a first reconfiguration message sent by the network device;
that the terminal device fails in handover to a second conditional handover target cell, wherein the second conditional handover target cell belongs to the at least one conditional handover target cell;
that the terminal device succeeds in handover to a third conditional handover target cell, wherein the third conditional handover target cell belongs to the at least one conditional handover target cell;
that a neighboring cell measurement task of the terminal device is started; or
that a signal measurement result, measured by the terminal device, of a serving cell is less than or equal to a first threshold.

4. The method according to claim 1, wherein the second condition comprises one or more of following conditions:
that the terminal device succeeds in receiving a second reconfiguration message sent by the network device;
that the terminal device fails in handover to a fourth conditional handover target cell, wherein the fourth conditional handover target cell belongs to the at least one conditional handover target cell;
that the terminal device succeeds in handover to a fifth conditional handover target cell, wherein the fifth conditional handover target cell belongs to the at least one conditional handover target cell;
that a neighboring cell measurement task of the terminal device is not started;
that a neighboring cell measurement task of the terminal device is stopped; or
that a signal measurement result, measured by the terminal device, of a serving cell is greater than or equal to a second threshold.

5. The method according to claim 1, wherein the method further comprises:
receiving, by the terminal device, first reconfiguration information sent by the network device; and
determining, by the terminal device based on the conditional handover configuration information and the first configuration information, a conditional handover target cell set on which handover condition evaluation needs to be performed when the handover condition evaluation task related to the conditional handover is started, wherein the conditional handover target cell set comprises the first conditional handover target cell.

6. The method according to claim 1, wherein the at least one conditional handover target cell comprises a primary cell (PCell) or a primary secondary cell (PSCell) that is configured for the terminal device.

7. A terminal device, comprising a memory and a processor, wherein the memory is configured to store a program, and the processor is configured to invoke the program in the memory to cause the terminal device to perform:
if a first condition is met, starting a handover condition evaluation task related to conditional handover; and/or
if a second condition is met, stopping or skipping starting the handover condition evaluation task related to the conditional handover,
wherein the handover condition evaluation task related to the conditional handover is used to evaluate whether a conditional handover event associated with a first conditional handover target cell is met, the first conditional handover target cell is one of at least one conditional handover target cell corresponding to conditional handover configuration information configured by a network device, and the conditional handover configuration information configured by the network device comprises configuration information corresponding to the at least one conditional handover target cell.

8. The terminal device according to claim 7, wherein the conditional handover configuration information configured by the network device is configured by a current serving cell of the terminal device or configured by a historical serving cell of the terminal device.

9. The terminal device according to claim 7, wherein the first condition comprises one or more of following conditions:
that the terminal device succeeds in receiving a first reconfiguration message sent by the network device;
that the terminal device fails in handover to a second conditional handover target cell, wherein the second conditional handover target cell belongs to the at least one conditional handover target cell;
that the terminal device succeeds in handover to a third conditional handover target cell, wherein the third conditional handover target cell belongs to the at least one conditional handover target cell;
that a neighboring cell measurement task of the terminal device is started; or
that a signal measurement result, measured by the terminal device, of a serving cell is less than or equal to a first threshold.

10. The terminal device according to claim 7, wherein the second condition comprises one or more of following conditions:
that the terminal device succeeds in receiving a second reconfiguration message sent by the network device;
that the terminal device fails in handover to a fourth conditional handover target cell, wherein the fourth conditional handover target cell belongs to the at least one conditional handover target cell;
that the terminal device succeeds in handover to a fifth conditional handover target cell, wherein the fifth conditional handover target cell belongs to the at least one conditional handover target cell;
that a neighboring cell measurement task of the terminal device is not started;
that a neighboring cell measurement task of the terminal device is stopped; or
that a signal measurement result, measured by the terminal device, of a serving cell is greater than or equal to a second threshold.

11. The terminal device according to claim 7, wherein the processor is configured to invoke the program in the memory to cause the terminal device to further perform:
receiving first configuration information sent by the network device; and
determining, based on the conditional handover configuration information and the first configuration information, a conditional handover target cell set on which handover condition evaluation needs to be performed when the handover condition evaluation task related to the conditional handover is started, wherein the conditional handover target cell set comprises the first conditional handover target cell.

12. The terminal device according to claim 11, wherein
the first configuration information comprises at least one piece of frequency information of a neighboring cell; or
the first configuration information comprises at least one piece of physical cell identity (PCI) information associated with each piece of frequency information in the at least one piece of frequency information; or
the first configuration information is associated with a current serving cell of the terminal device.

13. The terminal device according to claim 7, wherein the at least one conditional handover target cell comprises a primary cell PCell or a primary secondary cell PSCell that is configured for the terminal device.

14. A network device, comprising a memory and a processor, wherein the memory is configured to store a program, and the processor is configured to invoke the program in the memory to cause the network device to perform:
sending a reconfiguration message to a terminal device, wherein the reconfiguration message is used to instruct the terminal device to start a handover condition evaluation task related to conditional handover; and/or the reconfiguration message is used to instruct the terminal device to stop or skip starting the handover condition evaluation task related to the conditional handover,
wherein the handover condition evaluation task related to the conditional handover is used to evaluate whether a conditional handover event associated with a first conditional handover target cell is met, the first conditional handover target cell is one of at least one conditional handover target cell corresponding to conditional handover configuration information configured by the network device, and the conditional handover configuration information configured by the network device comprises configuration information corresponding to the at least one conditional handover target cell.

15. The network device according to claim 14, wherein the conditional handover configuration information configured by the network device is configured by a current serving cell of the terminal device or configured by a historical serving cell of the terminal device.

16. The network device according to claim 14, wherein the processor is configured to invoke the program in the memory to cause the network device to further perform:
sending first configuration information to the terminal device, wherein the first configuration information is used to determine a conditional handover target cell set, and the conditional handover target cell set comprises a conditional handover target cell, wherein the conditional handover target cell is associated with a conditional handover event and handover condition evaluation needs to be performed on the conditional handover target cell when the handover condition evaluation task related to the conditional handover is started, and the conditional handover target cell set comprises the first conditional handover target cell.

17. The network device according to claim 16, wherein
the first configuration information comprises at least one piece of frequency information of a neighboring cell; or
the first configuration information comprises at least one piece of physical cell identity PCI information associated with each piece of frequency information in the at least one piece of frequency information; or
the first configuration information is associated with a current serving cell of the terminal device.

18. The network device according to claim 16, wherein the first condition comprises one or more of following conditions:
that the terminal device succeeds in receiving the reconfiguration message;
that the terminal device fails in handover to a second conditional handover target cell, wherein the second conditional handover target cell belongs to the at least one conditional handover target cell;
that the terminal device succeeds in handover to a third conditional handover target cell, wherein the third conditional handover target cell belongs to the at least one conditional handover target cell;
that a neighboring cell measurement task of the terminal device is started; or
that a signal measurement result, measured by the terminal device, of a serving cell is less than or equal to a first threshold.

19. The network device according to claim 16, wherein the second condition comprises one or more of following conditions:
that the terminal device succeeds in receiving the reconfiguration message;
that the terminal device fails in handover to a fourth conditional handover target cell, wherein the fourth conditional handover target cell belongs to the at least one conditional handover target cell;
that the terminal device succeeds in handover to a fifth conditional handover target cell, wherein the fifth conditional handover target cell belongs to the at least one conditional handover target cell;
that a neighboring cell measurement task of the terminal device is not started;
that a neighboring cell measurement task of the terminal device is stopped; or
that a signal measurement result, measured by the terminal device, of a serving cell is greater than or equal to a second threshold.

20. The network device according to claim 14, wherein the at least one conditional handover target cell comprises a primary cell PCell or a primary secondary cell PSCell that is configured for the terminal device.
